(19) United States
(12) Patent Application Publication
(10) Pub. No.: US 2018/0086970 A1
(43) Pub. Date: Mar. 29, 2018

(54) METHOD FOR PROVIDING EXTENDED RELEASE ANTIMICROBIAL IN HYDRAULIC FRACTURING APPLICATIONS

(71) Applicant: Lubrizol Oilfield Solutions, Inc., Wickliffe, OH (US)

(72) Inventors: Ronald Anderson, Coolville, OH (US); Mark Wanner, Aliquippa, PA (US)

(21) Appl. No.: 15/714,241

(22) Filed: Sep. 25, 2017

Related U.S. Application Data
(60) Provisional application No. 62/400,675, filed on Sep. 28, 2016.

(51) Int. Cl. C09K 8/68; C09K 8/80; E21B 43/267; E21B 37/00

(52) U.S. Cl. CPC C09K 8/68; E21B 37/00; E21B 43/267; C09K 8/80

(57) ABSTRACT

The present technology provides a method of inhibiting or eliminating bacteria encountered in an oil or gas producing operations, such as, for example, sulfur or acid producing bacteria or some other uncommon bacteria. The method involves delivering a slightly soluble antimicrobial composition (generally as a solid) to the formation in a proppant delivery stage of a hydraulic fracturing operation.

### BACKGROUND OF THE INVENTION

The present technology provides a method of inhibiting or eliminating bacteria encountered in an oil or gas producing operation, such as, for example, sulfur or acid producing bacteria or some other uncommon bacteria. The method involves delivering a slightly soluble antimicrobial composition (generally as a solid) to the formation in a proppant delivery stage of a hydraulic fracturing operation.

Hydraulic fracturing is a process in which large quantities of a fracturing fluid, such as water, along with a proppant, such as sand, and other additives (e.g., friction reducers, scale inhibitors, shale/clay control additives, biocides, etc.) are pumped into a formation at pressures high enough to fracture the rock around the formation. The fractures, or fissures, created by the process are propped open by the proppant, and oil and gas are allowed to flow from the fissures. The hydraulic fracturing process can occur in phases, whereby the fracturing fluid is delivered to and used to fracture a portion of the length of the formation, and then pulled back through the formation to fracture a portion of the formation behind the previously fractured portion of the formation.

The fracturing fluid employed in the hydraulic fracturing process is generally pumped from tanker trucks through a pumping truck, where the fluid is mixed with the proppant and other chemicals and then pumped down the well. An antimicrobial is generally mixed with the fracturing fluid within the pumper truck before the fluid is pumped into the well. Placement of the anti-microbial at the pump-truck portion of the fracturing job is for the purpose of sterilizing the fluid to remove bacteria that might otherwise degrade the gelling fluid (guar or other organic)

The anti-microbial placed in the pumper truck is most usually added as a solution, although some forms of anti-microbial are soluble enough that they can be added as a solid to the fracturing fluid on the fly. A problem with the use of anti-microbial solutions/soluble anti-microbial solids is that they may only disinfect the fracturing fluid and be spent before making it any significant way into the well. For those anti-microbial compositions that do make it into the formation, the solubility of the compositions results in only a short term (e.g., 30 to 60 days max) anti-microbial affect. In either event, bacteria from within the well and in the formation can still result in undesirable contaminates in the hydrocarbon product of the well.

A need therefore exists for a method of providing to a fractured matrix extended (e.g. 6 months or more) protection from undesirable bacteria.

### SUMMARY OF THE INVENTION

The disclosed technology, therefore, solves the problem of inhibiting or eliminating sulfur producing bacteria in an oil or gas producing formation by delivering a slightly soluble antimicrobial composition to the formation in a proppant delivery stage of a hydraulic fracturing operation.

In an embodiment, the disclosed technology provides a method of providing long term preservation of a wellbore. The method can comprise, consist essentially of, or consist of delivering a solid slightly soluble antimicrobial composition through the wellbore to a formation around the wellbore in a proppant delivery stage of a hydraulic fracturing operation in an effective amount to inhibit or eliminate microbial growth in the formation. The method also includes fracturing the formation to allow the flow of the antimicrobial composition into the fractures formed in the formation and extracting a product from the formation through the wellbore, wherein the product is substantially free of or free of wellbore damaging microbes.

In the above method, the antimicrobial composition can comprise, consist essentially of, or consist of 2-bromo-2-bromomethylglutaronitrile; 2,2-dibromo-3-nitrilopropionamide; or combinations thereof.

In some embodiments, the antimicrobial composition can have two different slightly soluble antimicrobial agents, such as 2-bromo-2-bromomethylglutaronitrile and 2,2-dibromo-3-nitrilopropionamide, in a weight ratio of from about 20:1 to about 1:10.

Similarly, the method can include delivering from about 100 to 500 ppm of 2-bromo-2-bromomethylglutaronitrile and 100 to 600 ppm of 2,2-dibromo-3-nitrilopropionamide in a weight ratio of 20:1 to 1:10.

The technology also includes a hydraulic fracturing fluid. The fluid can comprise, consist essentially of, or consist of water, a proppant, and a slightly solid soluble antimicrobial composition.

### DETAILED DESCRIPTION OF THE INVENTION

Various preferred features and embodiments will be described below by way of non-limiting illustration.

The disclosed technology includes a method of providing long term preservation of a wellbore. The method encompasses delivering a slightly soluble antimicrobial composition through a wellbore into a formation around the wellbore in a proppant delivery stage of a hydraulic fracturing operation.

As used herein, the phrases “antimicrobial” and “inhibiting microbial growth” describe the killing of, as well as the inhibition of or control of the growth of bacteria, yeasts, fungi, and algae.

The method involves mixing the slightly soluble antimicrobial composition and a proppant, among other additives, to a hydraulic fracturing fluid (also referred to simply as the “fluid”), followed by delivery of the fluid to the formation. The fluid can be delivered to the formation in proppant delivery stages of the hydraulic fracturing operation. That is to say, the end of the formation may be fractured in a first stage, followed by successive fractures of the formation in later stages moving from the end of the formation back toward the well-bore.

The fracturing of the formation allows not only the proppant to prop open fissures, but also the delivery of the slightly soluble antimicrobial composition into the fissures formed in the formation. The use of the slightly soluble antimicrobial composition can inhibit or eliminate microbial growth within the formation, either within the fissures, on the inner walls of the formation, in the hydraulic fracturing fluid, or even within the product fluid (e.g., natural gas/crude oil).

The slightly soluble antimicrobial composition, generally, is least soluble, and therefore most effective in the solid form, including for example, finely divided powders and granular materials. However, the slightly soluble antimicrobial composition may also be employed as a liquid, such as in solutions, emulsions, suspensions, concentrates, emulsifiable concentrates, slurries and the like. The important factor determining the form with which to employ the slightly soluble antimicrobial composition is that it must be only slightly soluble in the hydraulic fracturing fluid to which it is added. In order for the antimicrobial composition to make it to the fracturing stage and delivered to the fissures formed in the formation, the antimicrobial composition cannot be used up. As a soluble solution, the antimicrobial will be active too soon within the fracturing process and, as previously mentioned, lose its activity either within the storage tanks, pumper truck or shortly into the well. As a slightly soluble composition, the antimicrobial composition can slowly dissolve over time to provide extended periods of antimicrobial protection.

The antimicrobial compositions useful in the disclosed methods are not particularly limited, except for the solubility parameters in relation to the fracturing fluid. Several known compositions can include, for example, 2-Bromo-2-Nitropropane-1,3-Diol; 3,5 -Dimethyl-2H, -1,3 ,5,thiadiazine-2-Thione; 2-bromo-2-bromomethylglutaronitrile; and 2,2-dibromo-3-nitrilopropionamide. These compositions are slightly soluble when in the solid form. Combinations of the foregoing may also be employed. In some embodiments the antimicrobial composition can include 2-Bromo-2-Nitropropane-1,3-Diol in combination with 3,5-Dimethyl-2H,-1,3,5,thiadiazine-2-Thione. In other embodiments, the antimicrobial composition can include 2-Bromo-2-Nitropropane-1,3-Diol in combination with 2-bromo-2-bromomethylglutaronitrile. In other embodiments, the antimicrobial composition can include 2-Bromo-2-Nitro-propane-1,3-Diol in combination with 2,2-dibromo-3-nitrilopropionamide. Further embodiments can include 3,5-Dimethyl-2H,-1,3,5,thiadiazine-2-Thione in combination with either 2-bromo-2-bromomethylglutaronitrile and/or 2,2-dibromo-3-nitrilo-propionamide. The antimicrobial composition can also include the combination of 2-bromo-2-brom omethylglutaronitrile with 2,2-dibromo-3 -nitrilopropionamide. Combinations of three or more slightly soluble antimicrobial compositions are also contemplated.

Where a combination of slightly soluble antimicrobial compositions are employed, the combination can include a first slightly soluble antimicrobial to a second slightly soluble antimicrobial in a weight ratio of first:second of from about 20:1 to about 1:10. Other ratios can also be effective, such as, for example, from about 15:1 to 1:7.5 or 10:1 to 1:5, or even 5:1 to 1:6. For example, 2-bromo-2-bromo-methylglutaronitrile may be employed with 2,2-dibromo-3-nitrilopropionamide at a ratio of from about 20:1 to about 1:10, or any of the other discussed ratios.

In an embodiment, from about 100 to 500 ppm of a first slightly soluble antimicrobial composition, such as, for example, 2-bromo-2-bromomethylglutaro-nitrile, and from about 100 to 600 ppm of a second slightly soluble antimicrobial composition, such as, for example, 2,2-dibromo-3-nitrilopropionamide, can be used in a weight ratio as described above.

Of course, the precise dosages of the components which will be employed depends upon a number of factors. First, the dosage is indicated in parts per million (ppm), which refers to the concentration of the active ingredient in the environment being treated. This concentration is based on 100% active ingredient for convenience in evaluating and comparing test data. In actual practice, however, various percentages of active ingredient may actually be used, with the balance of the composition being added comprising conventional excipients such as dispersants, stabilizers, preservatives, co-solvents, diluents, and the like.

It will be understood also that the slightly soluble antimicrobial combination may be used in combination with other antimicrobial materials. For example, the combination can be combined with other fungicides and bactericides such as 2-(4′-thiazolyl)benzimidazole, sorbic acid, propionic acid, mycostatin, sodium diacetate, trichomycin, amphotericin, griseofulvin, undecylenic acid, esters of parahydroxybenzoic acid, chlorguinaldol, 5,7-dichloro-8-hydroxyquinoline, sodium-o-phenylphenate, o-phenylphenol, biphenyl chlorinated phenols, sodium benzoate, or even more soluble forms of the slightly soluble antimicrobials, such as, for example, pre-dissolved 2-Bromo-2-Nitropropane-1,3 -Diol; 3,5 -Dimethyl-2H, -1,3,5,thiadiazine-2-Thione; 2-bromo-2-bromomethylglutaronitrile; and 2,2-dibromo-3-nitrilopropionamide in appropriate concentrations and in appropriate instances so as to combine the action of each to obtain particularly useful results. It is quite clear also that the slightly soluble antimicrobial combination can be combined with other algicidal agents such as benzalkonium chlorides and other quaternary ammonium compounds to obtain formulations particularly suitable to special problems of algae control.

The present technology also includes a fracturing fluid comprising. The fracturing fluid would include water, a proppant and the slightly soluble antimicrobial composition.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

As used herein, the term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. A method of providing long term preservation of a wellbore comprising the steps of:
a) delivering a solid or slightly soluble antimicrobial composition through the wellbore to a formation around the wellbore in a proppant delivery stage of a hydraulic fracturing operation in an effective amount to inhibit or eliminate microbial growth in the formation, and
b) fracturing the formation to allow the flow of the antimicrobial composition into the fractures formed in the formation,
c) extracting a product from the formation through the wellbore, wherein the product is substantially free of or free of wellbore damaging microbes.

2. The method of claim 1, wherein the antimicrobial composition comprises:
(i) 2-bromo-2-bromomethylglutaronitrile (“DBDCB”),
(ii) 2,2-dibromo-3-nitrilopropionamide (“DBNPA”), or
(iii) combinations of a) and b).

3. The method of claim 2, wherein the antimicrobial composition comprises a combination of (i) and (ii) in a weight ratio of (i):(ii) of from about 20:1 to about 1:10.

4. The method of claim 3, wherein 100 to 500 ppm of 2-bromo-2-bromomethylglutaronitrile and 100 to 600 ppm of 2,2-dibromo-3-nitrilopropionamide are used in a weight ratio of 20:1 to 1:10.

5. The method of claim 1 wherein the solid antimicrobial composition has a solubility in water of 1 g/l or less as measured by adding a weighed portion of the antimicrobial composition in 1 liter of DI water at room temperature with stirring, and continuing to add either additional antimicrobial composition until precipitation is observed, or further DI water until no further solids are observed.

6. A fracturing fluid comprising:
a) water,
b) a proppant,
c) a solid or slightly soluble antimicrobial composition.
